(19) United States
(12) Patent Application Publication
(10) Pub. No.: US 2026/0202012 A1
(43) Pub. Date: Jul. 16, 2026

(54) PIVOTING BRACKET

(71) Applicants: Scott M. Stilwell, Davidson, NC (US); Noah R. Davis, Mooresville, NC (US); Kevin J. Csehoski, Huntersville, NC (US)

(72) Inventors: Scott M. Stilwell, Davidson, NC (US); Noah R. Davis, Mooresville, NC (US); Kevin J. Csehoski, Huntersville, NC (US)

(21) Appl. No.: 19/444,945

(22) Filed: Jan. 9, 2026

Related U.S. Application Data
(60) Provisional application No. 63/744,013, filed on Jan. 10, 2025.

(51) Int. Cl. F16M 13/02; F16L 3/16

(52) U.S. Cl. CPC F16M 13/022; F16L 3/16

(57) ABSTRACT

A pivoting bracket 10 comprising a base plate 20, an upright base 30 secured to the base plate 20, wherein the upright base 30 has a first side of a hinge, an upright swing arm 40 hingedly secured to the upright base 30, wherein the upright swing arm 40 has a second side of the hinge which corresponds to and mates with the first side of the hinge, and a center axle 55 joining the first side of the hinge to the second side of the hinge.

### FIELD OF THE INVENTION

The present invention relates to an apparatus which aids in the support of flexible cables and hoses, collectively referred to as conduits. Specifically, this invention relates to the prevention of premature wear and failure of a support apparatus.

### RELATED CASES

### This claims the benefit of United States Provisional Patent Application No 63/744,013 filed on January 10, 2025. The full disclosure of this application is expressly incorporated herein by reference

### BACKGROUND OF THE INVENTION

Heavy Duty trucks utilize pressurized rubber hoses and electrical lines to connect and operate brakes, lights, hydraulics, and other mechanical functions on the trailer. These lines can be 12to 20feet long and are supported between the tractor and trailer by a variety of support mechanisms including bungee cords, springs, pogo sticks or tensioning systems. These support mechanisms are generally connected to the back of the truck in a static location. This static mount causes undue strain on the support mechanism when the truck/trailer makes sharp turns, backing maneuvers, or Jack-knifing. This strain also causes premature wear and failure of the support mechanism due to the extreme turns trucks must make in parking lots and while making U-turns on the road. When the support mechanism fails the air, electric, and hydraulic lines fall to the catwalk of the truck or onto the roadway leading to failure of the mechanical systems (ie. brake, electric or hydraulic).

There remains a need for a device to aid in the support of conduits and the support mechanisms which support those conduits to prevent undue strain, premature ware, and failure.

### SUMMARY OF THE INVENTION

A pivoting bracket 10 comprising a base plate 20, an upright base 30 secured to the base plate 20, wherein the upright base 30 has a first side of a hinge, an upright swing arm 40 hingedly secured to the upright base 30, wherein the upright swing arm 40 has a second side of the hinge which corresponds to and mates with the first side of the hinge, and a center axle 55 joining the first side of the hinge to the second side of the hinge.

### BRIEF DESCRIPTION OF THE DRAWINGS

FIG. 1 is a perspective view of one embodiment of a pivoting bracket.

FIG. 1A is a perspective view of one embodiment of a pivoting bracket.

FIG. 2 is a perspective view of one embodiment of a self-lubricated flange bushing component of a pivoting bracket.

FIG. 3 is a perspective view of one embodiment of a threaded bolt component of a pivoting bracket.

FIG. 4 is a perspective view of one embodiment of a lock-nut component of a pivoting bracket.

FIG. 5 is a perspective view of one embodiment of a washer component of a pivoting bracket.

FIG. 6 is a perspective view of one embodiment of a base plate component of a pivoting bracket.

FIG. 6A is a perspective view of one embodiment of a base plate component of a pivoting bracket.

FIG. 7 is a perspective view of one embodiment of an upright base component of a pivoting bracket.

FIG. 8 is a perspective view of one embodiment of an upright swing component of a pivoting bracket.

FIG. 9 is a perspective view of one embodiment of a bumper component of a pivoting bracket.

FIG. 10 is a perspective view of one embodiment of a bumper screw component of a pivoting bracket.

FIG. 11 is a perspective view of one embodiment of a bumper nut component of a pivoting bracket.

FIG. 12 is a side view of one embodiment of a pivoting bracket.

FIG. 12A is a perspective view of one embodiment of the base of a hinge assembly of a pivoting bracket.

FIG. 13 is a top view of one embodiment the swing range of a pivoting bracket.

FIG. 14 is a perspective view of one embodiment of a bumper of a pivoting bracket.

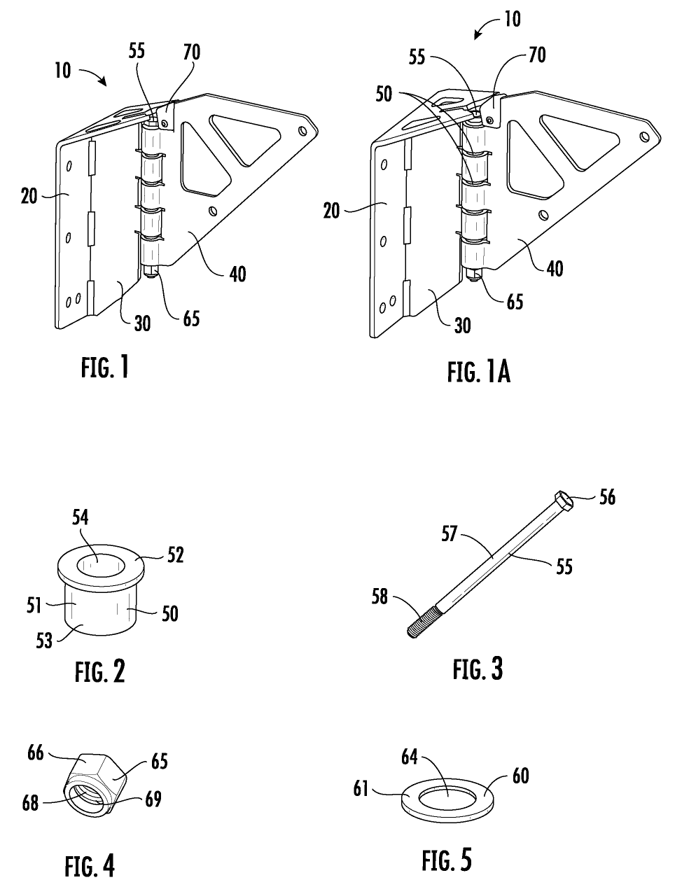

### DETAILED DESCRIPTION OF THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the present disclosure. In addition, descriptions of well-known functions and constructions may be omitted for clarity and conciseness.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents. Depending on the context of the sentence, the reading of this patent specification should be done with the same concept as “reject the absurd”, wherein if possible, a specification should be construed so as not to lead to a foolish result or one which the patentee could not have contemplated.

It is to be understood that the singular forms “a”, “an,” and “the” include plural referents unless the context clearly dictates otherwise. Thus, for example, reference to “a spring” includes reference to one or more of such springs.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

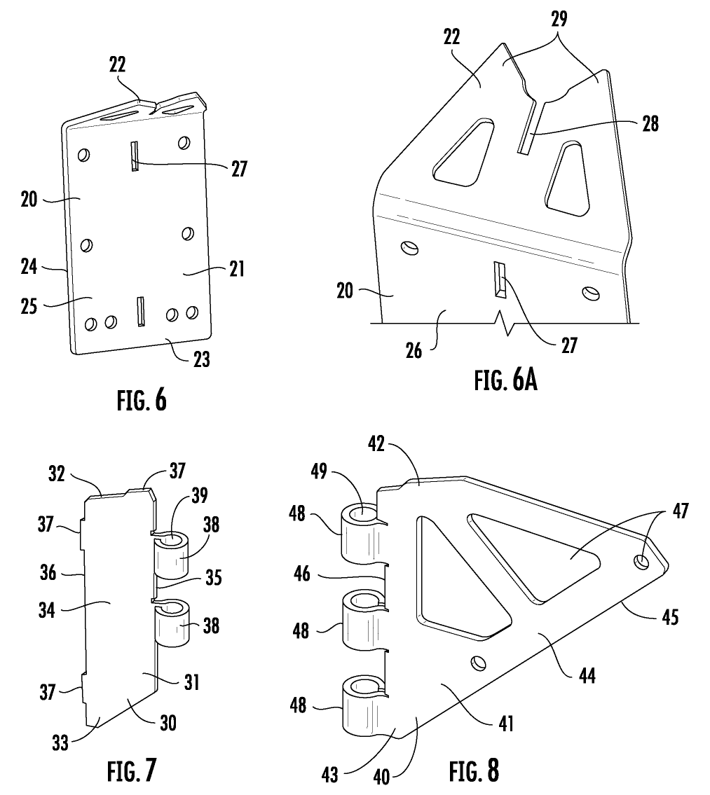

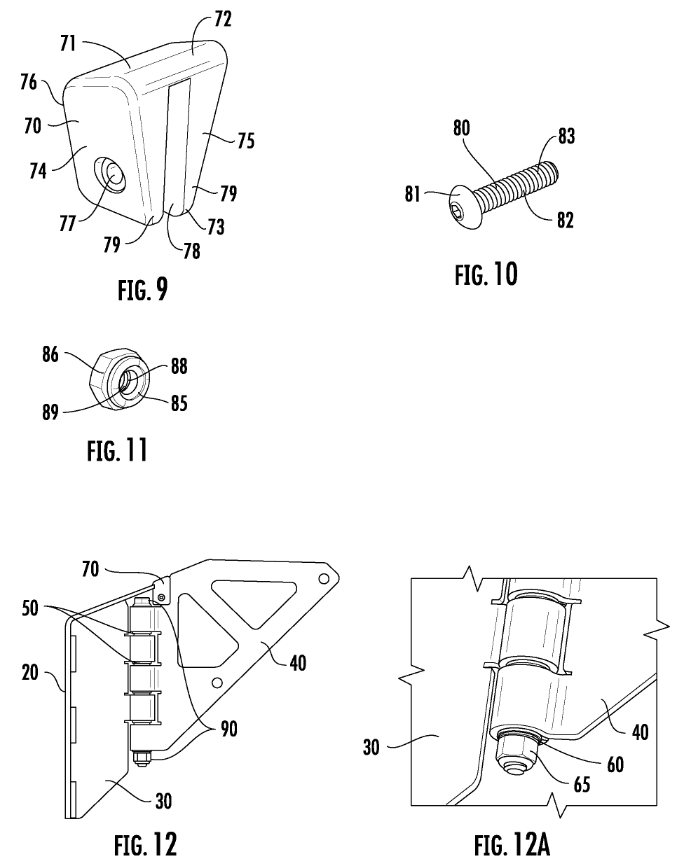

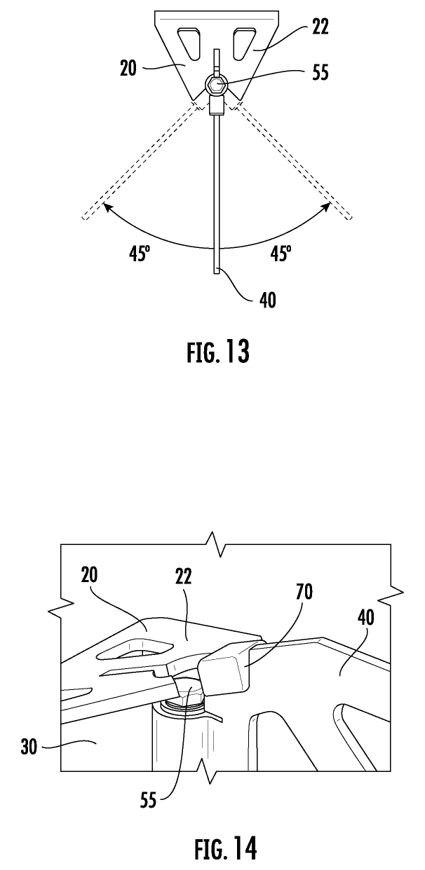

The present invention addresses the need for a device to aid in the support of conduits and the support mechanisms which support those conduits to prevent undue strain, premature wear, and failure of those conduits as well as in preventing the conduits from rubbing on the back of the tractor cab, avoiding damage to the paint on the cab itself and also additional rub/wear on the conduits themselves. To address these issues, an articulating/pivoting bracket was developed for use with various conduit/line support mechanisms. The pivoting bracket 10 utilizes a standard hinge (FIGS. 7 & 8) formed into the upright base 30 of the pivoting bracket 10 along with a center axle (e.g., threaded bolt 55 - FIG. 3). The hinge can be a standard butt hinge. A design feature of the base plate 20 (FIG. 6A) of the pivoting bracket 10 limits the extent of travel from left to right of the upright swing arm 40. The pivoting bracket 10 allows travel of the line support mechanism up to 90 degrees (FIG. 13). This pivoting bracket 10 includes a molded rubber bumper 70 (FIG. 9) to dampen any noise when the limit of articulation is reached. There are also self-lubricating (FIG. 2) flange bushings 50 installed in the hinge to minimize/eliminate binding or squeaking during operation or introduced to weather, road grime, salt, or dirt. The metal components are zinc-plated and powder-coated to resist rust and corrosion.

Looking now to the figures, where like numbers indicate like elements, there is shown a pivoting bracket 10 comprising a base plate 20, an upright base 30 secured to the base plate 20, wherein the upright base 30 has a first side of a hinge, an upright swing arm 40 hingedly secured to the upright base 30, wherein the upright swing arm 40 has a second side of the hinge which corresponds to and mates with the first side of the hinge, and a center axle 55 joining the first side of the hinge to the second side of the hinge.

The base plate 20 includes a body 21, an upper end 22, a lower end 23, a pair of sides 24, a front 25, a back 26, one or more apertures 27, a slot 28, and a pair of fingers 29. As illustrated in the figures, the body 21 of the base plate 20 is angled at its upper end 22 to aid in securing and stabilizing the upright base 30 when joined. The angled section of the base plate 20 can include one or more apertures, the slot 28, the pair of fingers 29.

The upright base 30 includes a body 31, an upper end 32, a lower end 33, a pair of sides 34, a front 35, a back 36, one or more extensions 37, and one or more knuckles 38 extending from the front 35 of the upright base 30. The knuckles 38 make up the first side of a hinge. Each knuckle includes a lumen 39 Into which other components are secured or through which other components pass through. The one or more extensions 37 correspond to and engage with the one or more apertures 27 of the base plate 20. The upright base 30 can be secured to the base plate 20 by any means known in the art, including but not limited to, welding or adhesives.

The upright swing arm 40 includes a body 41, an upper end 42, a lower end 43, a pair of sides 44, a front 45, a back 46, one or more apertures 47, and one or more knuckles 48 extending from the back 46 of the upright swing arm. The knuckles 48 make up the second side of the hinge. Each knuckle includes a lumen 49 Into which other components are secured or through which other components pass through. The upright swing arm 40 has a swing range of between 30 and 150 degrees, 45 to 135 degrees, 60 to 120 degrees, 30 to 90 degrees, 45 to 90 degrees, 60 to 90 degrees, or any combination thereof.

The pivoting bracket 10 can further include one or more bushings 50 secured within one or more knuckles 38, 48 of the upright base 30 and upright swing arm 40. Each bushing includes a body 51, a lip 52 extending outward from the body 51, an outer surface 53, and a lumen 54 through which other components pass through. The bushing can be any bushing known in the art including, but not limited to, a self-lubricated flange bushing.

A standard component of a hinge (e.g., butt hinge) is generally a pin or a threaded bolt 55. Any hinge pin or threaded bolt known in the art having the strength to maintain the connection between both sides of the hinge is acceptable. Looking at the figures, there is illustrated a threaded bolt which includes a head 56, a shaft 57, and a threaded section 58. Included when using a threaded bolt can be one or more washers 60 which include a body 61, and a lumen 64, as well as a nut 65 which includes a body 66 and a threaded section 68 located within a lumen 69 of the nut. The washer can be any type of washer known in the art including flat, split lock, external tooth lock, internal tooth lock, or any other washer known in the art having the strength to aid in maintaining the connection between the threaded bolt 55 and the nut 65. The nut 65 can be any nut known in the art having the strength to aid in maintaining the connection between the threaded bolt and the nut.

The pivoting bracket can further include a bumper 70 secured to the upright swing arm 40, wherein the bumper 70 dampens noise and reduces or prevents damage from upright swing arm 40 contacting the base plate 20 as the upright swing arm 40 swings back and forth. The bumper 70 includes a body 71, an upper end 72, a lower end 73, a pair of sides 74, a front 75, and a back 76. An aperture 77 is located through the body 71 of the bumper 70 and is designed to accommodate a bumper bolt 80 and bumper nut 85, or any similar devices know in the art, to secure the bumper 70 to the upright swing arm 40. Bumper 70 also includes a slot 78 defined by a pair of fingers 79. A portion of the upright swing arm 40 is inserted into the slot 78. This allows for a bumper bolt to be inserted through one side of the bumper, through an aperture in the upright swing arm, through the other side of the bumper, and held in place by a bumper nut 85. As illustrated the bumper screw 80 includes a head 81, a shaft 82, and threads 83. The bumper nut 85 includes a body 86, and a threaded section 88 located within a lumen 89 of the nut. The bumper 70 may be comprised of any substance known in the art to be resilient and dampen the noise created when components pivot and come into contact with one another. FIGS. 12 and 12A illustrate a hinge assembly 90 which includes the various components illustrated including a threaded bolt 55 and nut 65 securing the base plate 20 to the upright swing arm 40 with the bumper 70 secured in place on the upright swing arm.

The instant invention also includes a method to aid in supporting conduits and support mechanisms which support conduits to prevent undue strain, premature ware, and failure comprising:

a) providing a pivoting bracket 10 comprising

a base plate 20;

an upright base 30 secured to the base plate 20;

wherein the upright base 30 has a first side of a hinge;

an upright swing arm 40 hingedly secured to the upright base 30;

wherein the upright swing arm 40 has a second side of the hinge which corresponds to and mates with the first side of the hinge; and a center axle 55 joining the first side of the hinge to the second side of the hinge:

b) securing the pivoting bracket to a cab of a vehicle; and

c) securing conduits and/or support mechanisms which support the conduits to the upright swing arm;

wherein the conduits and/or support mechanisms are permitted to swing from the upright swing arm, preventing undue strain, premature wear, and failure from a turning action of the cab relative to a trailer.

Any method described herein may incorporate any design element contained within this application and any other document/application incorporated by reference herein.

To the accomplishment of the foregoing and related ends, one or more various embodiments include the features hereinafter fully described and particularly pointed out in the claims. The following description and the annexed drawings set forth in detail certain illustrative aspects and are indicative of but a few of the various ways in which the principles of the various embodiments may be employed. Other advantages and novel features will become apparent from the following detailed description when considered in conjunction with the drawings and the disclosed various embodiments are intended to include all such aspects and their equivalents.

Other aspects, advantages, and salient features of the disclosure will become apparent to those skilled in the art from the following detailed description, which, taken in conjunction with the annexed drawings, discloses various embodiments of the present disclosure.

While the present disclosure has been shown, and described with reference to various embodiments thereof, it will be understood by those ordinary skilled in the art that various changes in form and details may be made therein without departing from the scope of the present disclosure as defined by the appended claims and their equivalents.

What is claimed:

1. A pivoting bracket 10 comprising:
a base plate 20;
an upright base 30 secured to the base plate 20;
wherein the upright base 30 has a first side of a hinge;
an upright swing arm 40 hingedly secured to the upright base 30;
wherein the upright swing arm 40 has a second side of the hinge which corresponds to and mates with the first side of the hinge; and
a center axle 55 joining the first side of the hinge to the second side of the hinge.

2. The pivoting bracket 10 of claim 1 further comprising:
one or more bushings 50 secured within one or more knuckles 38, 48 of the upright base 30 and upright swing arm 40.

3. The pivoting bracket 10 of claim 1 further comprising:
a bumper 70 secured to the upright swing arm 40;
wherein the bumper 70 dampens noise and reduces or prevents damage from upright swing arm 40 contacting the base plate 20 as the upright swing arm 40 swings back and forth.

4. The pivoting bracket 10 of claim 1 wherein:
the base plate 20 is angled at its upper end 22 relative to a body 21 of the base plate.

5. The pivoting bracket 10 of claim 1 further comprising:
one or more apertures 27 located on a body 21 of the base plate 20;
one or more extensions 37 located on a body 31 of the upright base 30;
wherein the one or more extensions 37 are inserted into the one or more apertures 27 to secure the upright base 30 to the base plate 20.

6. The pivoting bracket 10 of claim 1:
wherein the center axle is a threaded bolt 55 and one or more washers 60 are secured at a threaded end of the threaded bolt 55; and
a nut 65 is secured at a threaded end of the threaded bolt 55.

7. The pivoting bracket 10 of claim 1 wherein:
the upright swing arm 40 has a swing range of between 30 and 150 degrees.

8. The pivoting bracket 10 of claim 7 wherein:
the upright swing arm has a swing range of between 0 and 90 degrees.

9. A method to aid in supporting conduits and support mechanisms which support conduits to prevent undue strain, premature ware, and failure comprising:
providing a pivoting bracket 10 comprising
a base plate 20;
an upright base 30 secured to the base plate 20;
wherein the upright base 30 has a first side of a hinge;
an upright swing arm 40 hingedly secured to the upright base 30;
wherein the upright swing arm 40 has a second side of the hinge which corresponds to and mates with the first side of the hinge; and
a center axle 55 joining the first side of the hinge to the second side of the hinge;
securing the pivoting bracket to a cab of a vehicle;
securing conduits and/or support mechanisms which support the conduits to the upright swing arm;
wherein the conduits and/or support mechanisms are permitted to swing from the upright swing arm, preventing undue strain, premature wear, and failure from a turning action of the cab relative to a trailer; and
wherein the conduits and/or support mechanisms are prevented from rubbing on the back of the tractor cab, avoiding damage to the paint on the cab itself and also additional rub/wear on the conduits themselves.

10. The method of claim 9 further comprising:
one or more bushings 50 secured within one or more knuckles 38, 48 of the upright base 30 and upright swing arm 40.

11. The method of claim 9 further comprising:
a bumper 70 secured to the upright swing arm 40;
wherein the bumper 70 dampens noise and reduces or prevents damage from upright swing arm 40 contacting the base plate 20 as the upright swing arm 40 swings back and forth.

12. The method of claim 9 wherein:
the base plate 20 is angled at its upper end 22 relative to a body 21 of the base plate.

13. The method of claim 9 further comprising:
one or more apertures 27 located on a body 21 of the base plate 20;
one or more extensions 37 located on a body 31 of the upright base 30;
wherein the one or more extensions 37 are inserted into the one or more apertures 27 to secure the upright base 30 to the base plate 20.

14. The method of claim 9:
wherein the center axle is a threaded bolt 55 and one or more washers 60 are secured at a threaded end of the threaded bolt 55; and
a nut 65 is secured at a threaded end of the threaded bolt 55.

15. The method of claim 9 wherein:
the upright swing arm 40 has a swing range of between 30 and 150 degrees.

16. The method of claim 15 wherein:
the upright swing arm has a swing range of between 0 and 90 degrees.
